(19) United States
(12) Patent Application Publication
(10) Pub. No.: US 2009/0169027 A1
(43) Pub. Date: Jul. 2, 2009

(54) ECHO SUPPRESSOR

(75) Inventors: Takefumi Ura, Kanagawa (JP); Takeo Kanamori, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/305,154

(22) PCT Filed: May 25, 2007
(86) PCT No.: PCT/JP2007/060677

§ 371 Date: Dec. 16, 2008

(30) Foreign Application Priority Data
Jun. 23, 2006 (JP) 2006-173750

(51) Int. Cl. H04B 3/20

(52) U.S. Cl. 381/66

(57) ABSTRACT

It is an object of the present invention to provide an echo suppressor which is simple in construction in comparison with the conventional echo suppressor, and which can suppress echoes corresponding to the spatial transfer paths, and reduce the amount of calculations necessary to suppress echoes. The echo suppressor is operative under the condition that transfer functions corresponding to spatial transfer paths between two or more loudspeakers (105, 106) and one or more microphones (107, 108) are estimated on the basis of symmetrical arrangement of the loudspeakers (105, 106) and the microphones (107, 108). The echo suppressor includes: a target signal generating unit (111) operable to generate target signals to be used to suppress echoes which are in signals indicating sounds received by the microphones (107, 108) from the loudspeakers (105, 106); a reference signal generating unit (112) operable to generate reference signals corresponding to the target signals on the basis of signals indicating sounds to be outputted from the loudspeakers (105, 106); and an echo suppressing unit (113) operable to suppress, on the basis of the target signals and the reference signals, echoes which are in signals indicating sounds received by the microphones (107, 108).

### TECHNICAL FIELD

The present invention relates to an echo suppressor operable to suppress echoes received by microphones from loudspeakers.

### BACKGROUND OF THE INVENTION

As an example, a conventional echo suppressor suppresses echoes by calculating cross spectrum between signals from microphones and the reference signals, and estimating spatial transfer characteristics between the loudspeakers and the microphones by using addition signals and subtraction signals calculated as reference signals from sound signals inputted into right and left channel loudspeakers (see, for example, Patent document 1).

FIG. 3 is a block diagram showing a conventional echo suppressor disclosed in patent document 1. Two microphones and two loudspeakers are arranged as shown in FIG. 3. The construction of the conventional echo suppressor shown in FIG. 3 will be described hereinafter.

The right and left channel stereo signals are respectively inputted into D/A converters 303 and 304 through input terminals 301 and 302. The digital-to-analog conversions of the right and left channel stereo signals are performed by the D/A converters 303 and 304, while the loudspeakers 305 and 306 output sounds represented by analog signals outputted from the D/A converters 303 and 304.

The sounds outputted from the loudspeakers 305 and 306 are received as echoes by the microphones 307 and 308 through spatial transfer paths hLL, hLR, hRL, and hRR, while analog-to-digital conversions of signals indicative of the sounds are performed by the A/D converters 309 and 310.

The addition/subtraction signal generating unit 321 generates an addition signal and a subtraction signal from the signals received through the input terminals 301 and 302 by using an adder 322 and a subtracter 323, while the correlation detecting unit 325 detects a correlation from the addition signal and the subtraction signal.

The transfer function calculating unit 324 estimates spatial transfer characteristics between the loudspeakers and the microphones. More specifically, the transfer function calculating unit 324 performs a cross-spectral analysis of output signals from the subtracters 319 and 320, and output signals from the addition/subtraction signal generating unit 321.

The filters 313, 314, 315, and 316 replicate spatial transfer characteristics hLL, hLR, hRL, and hRR corresponding to spatial transfer paths between loudspeakers 305, 306 and microphones 307, 308 by using coefficients calculated by a transfer function calculating unit 324.

An adder 317 generates a replica echo signal by adding one of signals outputted from the filters 313 and 314 to the other of the signals outputted from the filters 313 and 314. An adder 318 generates a replica echo signal by adding one of signals outputted from the filters 315 and 316 to the other of the signals outputted from the filters 315 and 316.

A subtracter 319 suppresses an echo forming part of a signal to be outputted to an output terminal 311 by subtracting the replica echo signal outputted from the adder 317 from the digital signal outputted from the A/D converter 309. A subtracter 320 suppresses an echo forming part of a signal to be outputted to an output terminal 312 by subtracting the replica echo signal outputted from the adder 318 from the digital signal outputted from the A/D converter 310.

Patent document 1: Japanese Patent Laying-Open Publication No. 2003-102085 (page 56, FIG. 1)

### DISCLOSURE OF THE INVENTION

### Problems to be Solved by the Invention

The conventional echo suppressor however encounters such a problem that the number of spatial transfer paths necessary to estimate and replicate spatial transfer characteristics increases with the number of loudspeakers and the number of microphones. Therefore, the conventional echo suppressor is required to perform complex calculations necessary to suppress echoes. The amount of calculations increases with the number of spatial transfer paths.

It is therefore an object of the present invention to provide an echo suppressor which is simple in construction in comparison with the conventional echo suppressor, and which can suppress echoes corresponding to the spatial transfer paths, and reduce the amount of calculations necessary to suppress echoes.

### Means for Solving the Problem

An echo suppressor according to the present invention is operative under the condition that transfer functions corresponding to spatial transfer paths between two or more loudspeakers and one or more microphones are estimated on the basis of symmetrical arrangement of the loudspeakers and the microphones. The echo suppressor comprises: a target signal generating unit operable to generate target signals to be used to suppress echoes which are in signals indicating sounds received by the microphones from the loudspeakers; a reference signal generating unit operable to generate reference signals corresponding to the target signals on the basis of signals indicating sounds to be outputted from the loudspeakers; and an echo suppressing unit operable to suppress, on the basis of the target signals and the reference signals, echoes which are in signals indicating sounds received by the microphones.

The echo suppressor thus constructed is simple in construction in comparison with the conventional echo suppressor, and can suppress echoes corresponding to the spatial transfer paths, and reduce the amount of calculations necessary to suppress echoes.

In the echo suppressor according to the present invention, loudspeakers are arranged symmetrically with respect to a center line, and the microphones are arranged symmetrically with respect to the center line.

The echo suppressor thus constructed is simple in construction, and can suppress echoes corresponding to the spatial transfer paths, and reduce the amount of calculations necessary to suppress echoes.

In the echo suppressor according to the present invention, when an odd number of loudspeakers are arranged symmetrically with respect to the center line, the center loudspeaker is disposed on the center line.

The echo suppressor thus constructed is simple in construction, and can suppress echoes corresponding to the spatial transfer paths, and reduce the amount of calculations necessary to suppress echoes.

In the echo suppressor according to the present invention, when an odd number of microphones are arranged symmetrically with respect to the center line, the center microphone is disposed on the center line.

The echo suppressor thus constructed is simple in construction, and can suppress echoes corresponding to the spatial transfer paths, and reduce the amount of calculations necessary to suppress echoes.

In the echo suppressor according to the present invention, the target signal generating unit may output, as the target signals, at least one of an addition signal based on the signals outputted from the microphones, a subtraction signal based on the signals outputted from the microphones, and a through signal.

The echo suppressor thus constructed is simple in construction, and can suppress echoes corresponding to the spatial transfer paths, and reduce the amount of calculations necessary to suppress echoes.

In the echo suppressor according to the present invention, the reference signal generating unit may output, as the reference signals, at least one of an addition signal based on signals to be outputted as sounds from the loudspeakers, a subtraction signal based on signals to be outputted as sounds from the loudspeakers, and a through signal.

The echo suppressor thus constructed is simple in construction, and can suppress echoes corresponding to the spatial transfer paths, and reduce the amount of calculations necessary to suppress echoes.

In the echo suppressor according to the present invention, the echo suppressing unit may use one or more adaptive filters.

The echo suppressor thus constructed is simple in construction, and can suppress echoes corresponding to the spatial transfer paths, and reduce the amount of calculations necessary to suppress echoes.

In the echo suppressor according to the present invention, the echo suppressing unit may perform an echo suppressing operation by using band-limited target signals and band-limited reference signals.

The echo suppressor thus constructed can reduce a processing load necessary to suppress echoes.

In the echo suppressor according to the present invention, the echo suppressing unit may update coefficients of the adaptive filters on the basis of judgments on whether or not the echoes are in the sound signals.

The echo suppressor thus constructed can enhance accuracy necessary to estimate spatial transfer characteristics.

The echo suppressor according to the present invention may further comprise: a signal combining unit operable to combine signals outputted from the echo suppressing unit, the signal combining unit generating signals by multiplying an addition signal based on signals outputted from the echo suppressing unit and a subtraction signal based on signals outputted from said echo suppressing unit by coefficients.

The echo suppressor thus constructed is simple in construction, and can suppress echoes corresponding to the spatial transfer paths, and reduce the amount of calculations necessary to suppress echoes.

### ADVANTAGE OF THE INVENTION

The echo suppressor according to the present invention is simple in construction in comparison with the conventional echo suppressor, can suppress echoes corresponding to spatial transfer characteristics, and can reduce calculations necessary to suppress the echoes.

### BRIEF DESCRIPTION OF THE DRAWINGS

FIG. 1 is a block diagram showing an echo suppressor according to the first embodiment of the present invention.

FIG. 2 is a block diagram showing an echo suppressor according to the second embodiment of the present invention.

FIG. 3 is a block diagram showing a conventional echo suppressor.

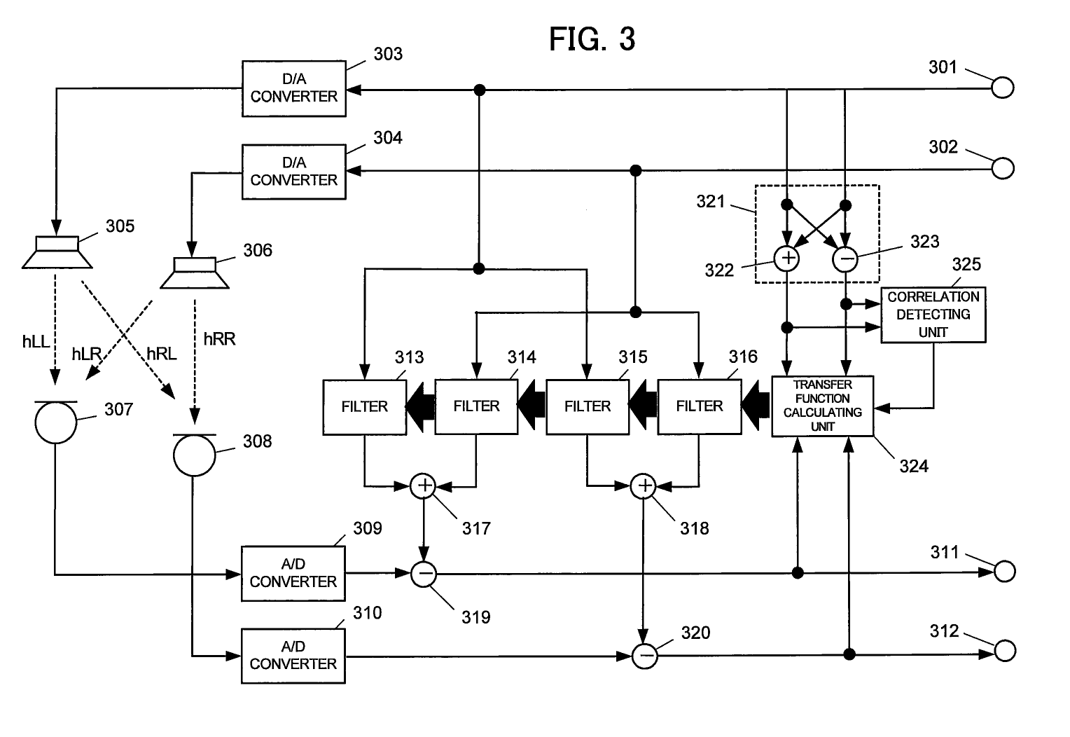

### EXPLANATION OF THE REFERENCE NUMERALS

101, 102, 301, 302: input terminal
103, 104, 303, 304: D/A converter
105, 106, 305, 306: loudspeaker
107, 108, 307, 308: microphone
109, 110, 309, 310: A/D converter
111: target signal generating unit
112: reference signal generating unit
113: echo suppressing unit
114: signal combining unit
115, 116, 311, 312: output terminal
117, 119, 125, 317, 318, 322: adder
118, 120, 123, 124, 126, 319, 320, 323: subtracter
121, 122: adaptive filter
127, 128: multiplier
201: echo detecting unit
313 to 316: filter
321: addition/subtraction signal generating unit
324: transfer function calculating unit
325: correlation detecting unit

### THE PREFERRED EMBODIMENTS OF THE INVENTION

The first and second embodiments of the echo suppressor according to the present invention will be described hereinafter with reference to accompanying drawings.

### First Embodiment

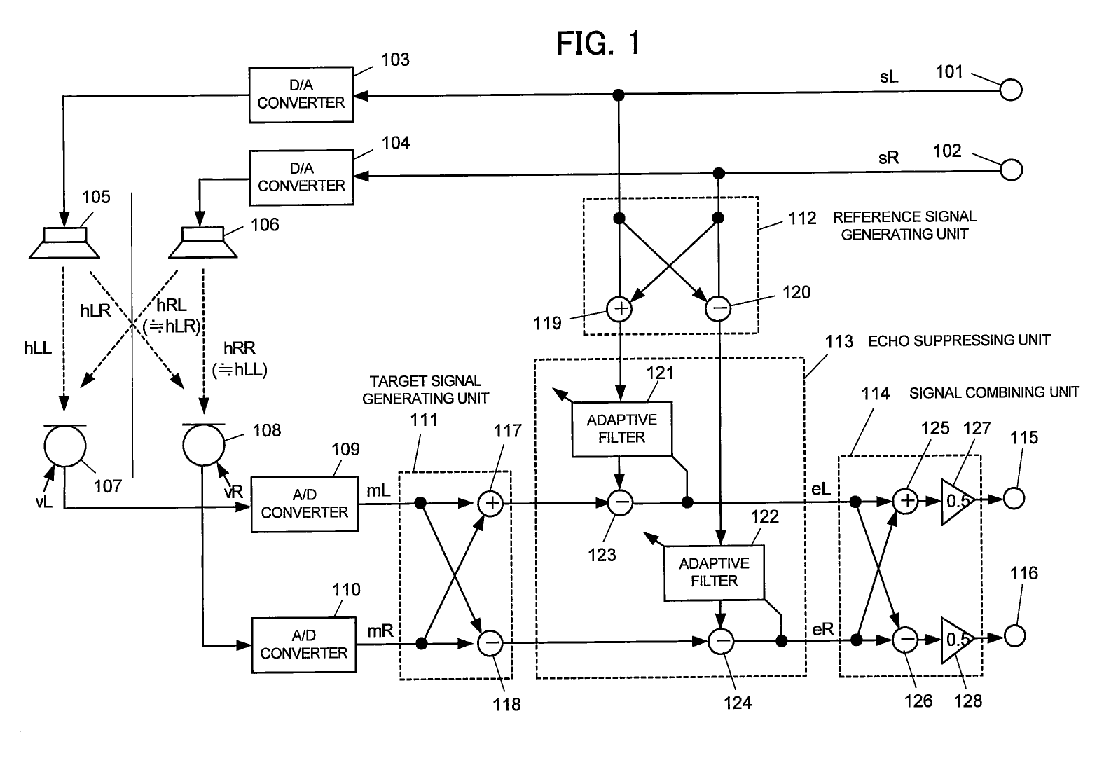

FIG. 1 is a block diagram showing an echo suppressor according to the first embodiment of the present invention. Two loudspeakers arranged symmetrically with respect to a center line, and two microphones arranged symmetrically with respect to the same center line are in FIG. 1. The construction of the echo suppressor shown in FIG. 1 will be described hereinafter.

As shown in FIG. 1, right and left channel stereo signals are inputted into digital-to-analog converters (D/A converters) 103 and 104 through input terminals 101 and 102, respectively. The digital-to-analog converters 103 and 104 perform digital-to-analog conversions of the right and left channel stereo signals, while the loudspeakers 105 and 106 output respective sounds generated from signals outputted from the D/A converters 103 and 104.

The sounds outputted from the loudspeakers 105 and 106 are received as echoes by the microphones 107 and 108 through spatial transfer paths hLL, hLR, hRL, and hRR. Here, the spatial transfer paths hLL, hLR, hRL, and hRR are approximated by following approximate expressions.

hRL≈hLR (1)

hRR≈hLL (2)

The analog-to-digital converters (A/D converters) 109 and 110 performs analog-to-digital conversions of the sounds received by the microphones 107 and 108. A target signal generating unit 111 has an adder 117 and a subtracter 118, and generates target signals from digital signals outputted from the A/D converters 109 and 110. Further, the target signal generating unit 111 may output signals received from the A/D converters 109 and 110 without change. Here, a signal inputted into the target signal generating unit 111, and outputted without change from the target signal generating unit 111 is simply referred to as “through signal”.

A reference signal generating unit 112 has an adder 119 and a subtracter 120, and generates an addition signal and a subtraction signal from the signals inputted through the input terminals 101 and 102, and outputs the addition signal and the subtraction signal to the echo suppressing unit 113 as reference signals. Here, the reference signal generating unit 112 may output through signals to an echo suppressing unit 113.

The echo suppressing unit 113 has adaptive filters 121 and 122, and subtracters 123 and 124, and performs an echo suppression on the basis of the target signals generated by the target signal generating unit 111 and the reference signals generated by the reference signal generating unit 112.

A signal combining unit 114 has an adder 125, a subtracter 126, and multipliers 127 and 128, and combines signals outputted from the echo suppressing unit 113. Here, the signal combining unit 114 may output through signals to the output terminals 115 and 116.

The operation of the echo suppressor according to the first embodiment of the present invention will be described hereinafter.

The stereo signals sL and sR are respectively inputted into the D/A converters 103 and 104 through the input terminals 101 and 102, while the digital-to-analog conversions of the stereo signals sL and sR are performed by the D/A converters 103 and 104. The signals outputted from the D/A converters 103 and 104 are respectively outputted as sounds by the loudspeakers 105 and 106.

The sounds outputted from the loudspeakers 105 and 106 are received as echoes by the microphones 107 and 108 through spatial transfer paths hLL, hLR, hRL, and hRR. The analog-to-digital conversions of the sounds received by the microphones 107 and 108 are respectively performed by the A/D converters 109 and 110.

Here, the above-mentioned approximate expressions (1) and (2) are respectively replaced by identity formulas. The signals mL and mR to be respectively outputted from the A/D converters 109 and 110 are represented by following identity formulas (3) and (4). Here, the legends “vL” and “vR” are intended to indicate sounds to be intrinsically received by the microphones 107 and 108. The symbol “*” is intended to indicate an operator corresponding to convolution.

mL=hLL*sL+hLR*sR+vL (3)

mR=hLR*sL+hLL*sR+vR (4)

The target signal generating unit 111 generates, by using the adder 117 and the subtracter 118, an addition signal “mL+mR” and a subtraction signal “mL−mR” as target signals to be outputted to the echo suppressing unit 113. The addition signal “mL+mR” and the subtraction signal “mL−mR” are represented by following identity formulas (5) and (6).

mL+mR=(sL+sR)*(hLL+hLR)+(vL+vR) (5)

mL−mR=(sL−sR)*(hLL−hLR)+(vL−vR) (6)

The reference signal generating unit 112 generates, by using the adder 119 and the subtracter 120, an addition signal “sL+sR” and a subtraction signal “sL−sR” as reference signals to be outputted to the echo suppressing unit 113.

The echo suppressing unit 113 calculates a replica echo signal by performing a convolution of the reference signal “sL+sR” and filter coefficients in the adaptive filter 121, and suppresses an echo by subtracting the calculated replica echo signal from the target signal shown by the identity formula (5) in the subtracter 123. Further, the echo suppressing unit 113 calculates a replica echo signal by performing a convolution of the reference signal “sL−sR” and filter coefficients in the adaptive filter 122, and suppresses an echo by subtracting the calculated replica echo signal from the target signal shown by the identity formula (6) in the subtracter 124.

The output signals to be outputted as error signals to the adaptive filters 121 and 122 from the subtracters 123 and 124 are represented by following identity formulas (7) and (8).

eL=vL+vR (7)

eR=vL−vR (8)

The filter coefficients to be used in the adaptive filters 121 and 122 are successively updated so as to minimize square mean values of the output signals shown by the identity formulas (7) and (8). The above operations to be performed by the adaptive filters 121 and 122 are equivalent to estimations of composed spatial transfer characteristics “hLL+hLR” and “hLL−hLR”. In this embodiment, the normalized least mean square (NLMS) algorithm or another conventional algorithm is applied as an algorithm for updating filter coefficients in the adaptive filters 121 and 122.

The signal combining unit 114 calculates an addition signal and a subtraction signal from the output signals eL and eR outputted from the echo suppressing unit 113 by using the adder 125 and the subtracter 126, calculates signals really required as sounds vL and vR by multiplying each of the addition and subtraction signals by 0.5 in two multipliers 127 and 128, and outputs the signals through the output terminals 115 and 116.

As will be seen from the foregoing explanation, the echo suppressor according to the first embodiment of the present invention can reduce the number of the spatial transfer paths to be estimated on the basis of symmetric arrangement of the loudspeakers and the microphone/microphones, and the number of echoes corresponding to the spatial transfer paths. Therefore, the echo suppressor according to the first embodiment of the present invention is simple in construction in comparison with the conventional echo suppressor, suppress echoes corresponding to the spatial transfer paths, and reduce the amount of calculations necessary to suppress the echoes.

Additionally, two loudspeakers and two microphones are arranged symmetrically in the echo suppressor according to the first embodiment of the present invention. However, the present invention is not limited by the number of the microphones and the number of the loudspeakers. Two or more loudspeakers and one or more microphones may be arranged symmetrically. In order to have the echo suppressor suppress echoes corresponding to the spatial transfer paths on the basis of symmetric arrangement of the loudspeakers and the microphone/microphones, the target signal generating unit 111, the reference signal generating unit 112, the echo suppressing unit 113, and the signal combining unit 114 are properly constructed.

When an odd number of loudspeakers are arranged symmetrically with respect to a center line, it is essential to dispose the middle loudspeaker on the center line. When, on the other hand, an odd number of microphones are arranged symmetrically with respect to a center line, it is essential to dispose the middle microphone on the center line. When the echoes to be suppressed by the echo suppressor are within a specific frequency range (for example, the power of echoes is mainly distributed in an audio frequency range), the echo suppressing unit 113 may suppress echoes by processing band limited audio signals

### Second Embodiment

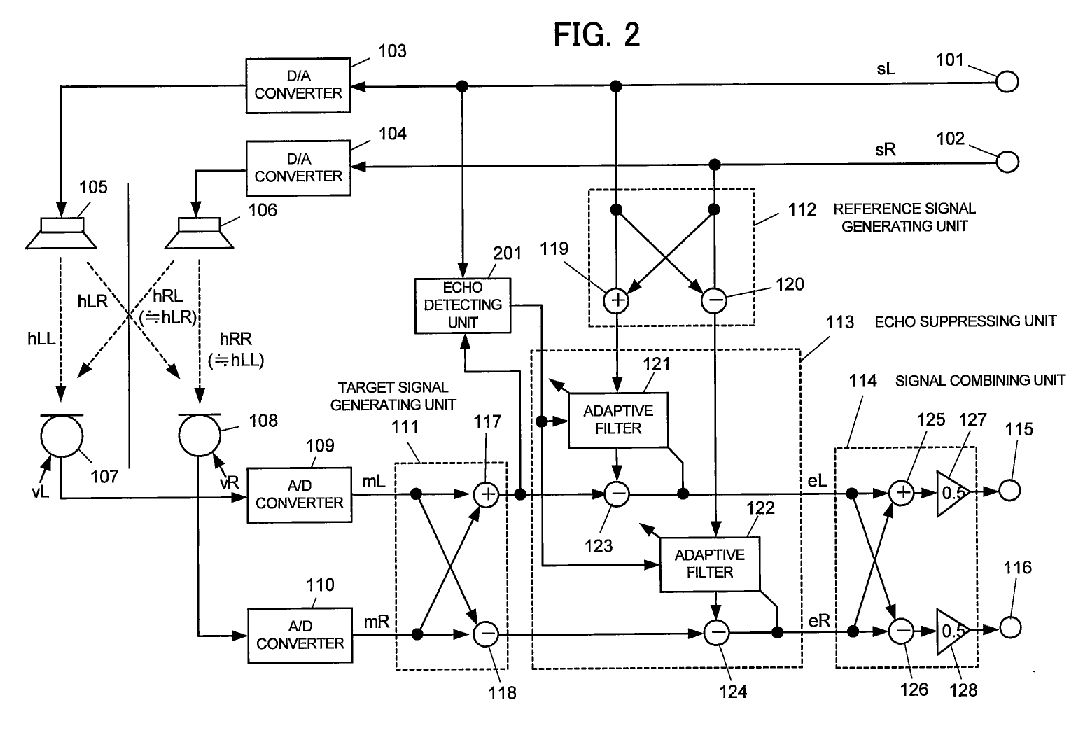

FIG. 2 is a block diagram showing an echo suppressor according to the second embodiment of the present invention. The components of the echo suppressor according to the second embodiment the same in construction as those of the echo suppressor according to the first embodiment will not be described, but bear the same reference numbers as those of the echo suppressor according to the first embodiment.

The echo suppressor shown in FIG. 2 further comprises an echo detecting unit 201 in comparison with the echo suppressor shown in FIG. 1.

The echo detecting unit 201 calculates a mutual correlation between an input signal from an input terminal 101 and an output signal from the adder 117 forming part of the target signal generating unit 111, determines whether or not the input signal has an echo on the basis of the calculated mutual correlation, and controls whether or not to update filter coefficients of the adaptive filters 121 and 122 on the basis of the determination. When, for example, the echo detecting unit 201 detects an echo from the input signal, the echo suppressing unit 113 updates the filter coefficients of the adaptive filters 121 and 122.

From the foregoing description, it will be understood that the echo suppressor according to the second embodiment of the present intention can estimate spatial transfer characteristics with accuracy by updating filter coefficients on the basis of the determination on whether the input signal has an echo.

In the echo suppressor according to the second embodiment, the echo detecting unit 201 calculates a mutual correlation between an input signal from an input terminal 101 and an output signal from the adder 117 forming part of the target signal generating unit 111. However, the echo detecting unit 201 may calculate a ratio between an input signal from an input terminal 101 and an output signal from the adder 117 instead of the mutual correlation. The echo detecting unit 201 may use an input signal from an input terminal 102 and an output signal from the adder 117 forming part of the target signal generating unit 111. The echo suppressor may comprise echo detecting units corresponding to respective adaptive filters. Each of the adaptive filters may use appropriate signals to update filter coefficients with accuracy.

### INDUSTRIAL APPLICABILITY

As will be seen form the foregoing description, the echo suppressor according to the present invention is simple in construction in comparison with the conventional echo suppressor, and can suppress echoes corresponding to spatial transfer paths, and is available as an echo suppressor for suppressing echoes received by one or more microphones from loudspeakers in an audio apparatus having two or more loudspeakers and one or more microphones.

1: An echo suppressor for suppressing echoes under the condition that first and second microphones are substantially symmetrical with respect to a center line, and first and second loudspeakers are substantially symmetrical with respect to said center line,
said echo suppressor comprising:
a target signal generating unit operable to generate a first target signal by adding a signal from said second microphone to a signal from said first microphone, and to generate a second target signal by subtracting said signal to said first microphone from said signal to said second microphone;
a reference signal generating unit operable to generate a first reference signal by adding a signal to said second loudspeaker to a signal to said first loudspeaker, and to generate a second reference signal by subtracting said signal to said first loudspeaker from said signal to said second loudspeaker; and
an echo suppressing unit operable to generate a first echo suppression signal from said first target signal generated as a target signal and said first reference signal generated as a reference signal by driving a first adaptive filter, and to generate a second echo suppression signal from said second target signal generated as said target signal and said second reference signal generated as said reference signal by driving a second adaptive filter.

2: The echo suppressor according to claim 1, further comprising:
a signal combining unit operable to generate a first combined signal by adding said second echo suppression signal to said first echo suppression signal, and to generate a second combined signal by subtracting said first echo suppression signal from said second echo suppression signal.

3: The echo suppressor according to claim 2, wherein
said signal combining unit multiples said first and second combined signals by respective predetermined coefficients.

4: The echo suppressor according to claim 1, wherein
said echo suppressing unit performs an echo suppressing operation by using band-limited target signals and band-limited reference signals.

5: The echo suppressor according to claim 1 or claim 4, wherein
said echo suppressing unit updates coefficients of said adaptive filters on the basis of judgments on whether or not said echoes are in said signals from said first microphone and from said second microphone.

6: An echo suppressor for suppressing echoes under the condition that a microphone is located on a center line, and first and second loudspeakers are substantially symmetrical with respect to said center line,
said echo suppressor comprising:
a target signal generating unit operable to output, as a target signal, a signal from said microphone;
a reference signal generating unit operable to generate a reference signal by adding a signal to said second loudspeaker to a signal to said first loudspeaker; and
an echo suppressing unit operable to generate an echo suppression signal from said target signal and said reference signal by driving an adaptive filter.

7: The echo suppressor according to claim 6, wherein
said echo suppressing unit performs an echo suppressing operation by using band-limited target signals and band-limited reference signals.

8: The echo suppressor according to claim 6 or claim 7, wherein
said echo suppressing unit updates coefficients of said adaptive filters on the basis of judgments on whether or not said echoes are in said signals from said first microphone and from said second microphone.

9-10. (canceled)

11: A method of suppressing echoes under the condition that first and second microphones are substantially symmetrical with respect to a center line, and first and second loudspeakers are substantially symmetrical with respect to said center line,
said method comprising:
generating a first target signal by adding a signal from said second microphone to a signal from said first microphone, and generating a second target signal by subtracting said signal to said first microphone from said signal to said second microphone;
generating a first reference signal by adding a signal to said second loudspeaker to a signal to said first loudspeaker, and generating a second reference signal by subtracting said signal to said first loudspeaker from said signal to said second loudspeaker; and
generating a first echo suppression signal from said first target signal generated as a target signal and said first reference signal generated as a reference signal by driving a first adaptive filter, and generating a second echo suppression signal from said second target signal generated as said target signal and said second reference signal generated as said reference signal by driving a second adaptive filter.

12: The method according to claim 11, which generates a first combined signal by adding said second echo suppression signal to said first echo suppression signal, and generates a second combined signal by subtracting said first echo suppression signal from said second echo suppression signal.

13: The method according to claim 12, which multiples said first and second combined signals by respective predetermined coefficients.

14: The method according to claim 11, which performs an echo suppressing operation by using band-limited target signals and band-limited reference signals.

15: The method according to claim 11 or claim 14, which updates coefficients of said adaptive filters on the basis of judgments on whether or not said echoes are in said signals from said first microphone and from said second microphone.

16: An method for suppressing echoes under the condition that a microphone is located on a center line, and first and second loudspeakers are substantially symmetrical with respect to said center line,
said method comprising:
outputting as a target signal, a signal from said microphone;
generating a reference signal by adding a signal to said second loudspeaker to a signal to said first loudspeaker; and
generating an echo suppression signal from said target signal and said reference signal by driving an adaptive filter.

17: The method according to claim 16, which performs an echo suppressing operation by using band-limited target signals and band-limited reference signals.

18: The method according to claim 16 or claim 17, which updates coefficients of said adaptive filters on the basis of judgments on whether or not said echoes are in said signals from said first microphone and from said second microphone.
